(19) United States
(12) Patent Application Publication
(10) Pub. No.: US 2011/0225151 A1
(43) Pub. Date: Sep. 15, 2011

(54) METHODS, DEVICES, AND COMPUTER PROGRAM PRODUCTS FOR CLASSIFYING DIGITAL MEDIA FILES BASED ON ASSOCIATED GEOGRAPHICAL IDENTIFICATION METADATA

(76) Inventors: Srinivas Annambhotla, Foster City, CA (US); Muralimohan Gopalakrishna, Morrisville, NC (US); Gregory A. Dunko, Cary, NC (US)

(21) Appl. No.: 12/723,890

(22) Filed: Mar. 15, 2010

(51) Int. Cl. G06F 17/30; G06F 3/048; G06F 15/16

(52) U.S. Cl. 707/724; 715/772; 715/835; 707/732; 709/219; 707/731; 707/E17.089; 707/E17.018; 707/E17.11

(57) ABSTRACT

A method for classifying digital media files includes obtaining geographical information from geographical identification metadata associated with one or more digital media files stored in a memory of a mobile terminal, and assigning a respective ranking to the one or more digital media files within one or more media classification categories based on the obtained geographical information. A summary view of the one or more ranked digital media files is displayed, the summary view including two axes, each axis corresponding to at least one of the one or more media classification categories. A travel profile for a user of the mobile terminal, including the user's travel preferences as determined by the respective ranking of at least one ranked digital media file in one or more of the media classification categories, is generated, and relevant travel information is presented to the user. Related devices and computer program products are also discussed.

### FIELD OF THE INVENTION

The present invention relates to the classification of digital media files.

### BACKGROUND OF THE INVENTION

Portable electronic devices, such as mobile terminals, increasingly provide a variety of communications, multimedia, and/or data processing capabilities. For example, mobile terminals, such as cell phones and personal digital assistants, may provide access to data in a wide variety of multimedia formats, including pictures, video, and/or music.

Conventional mobile terminals often include an integrated digital camera for capturing digital still photographs or digital video and/or an integrated microphone capable of recording digital audio, as well as a positional receiver, such as a Global Positioning System (GPS) receiver, that can be used to determine an approximate geographical location of the mobile terminal. Increasingly, such mobile terminals also provide built-in support for “geotagging,” or associating geographical identification metadata with, a digital media file created using the mobile terminal. This geographical identification metadata may include information identifying the location (e.g., the latitude and longitude coordinates, elevation, altitude) where the digital media file was created, and/or information regarding other conditions (e.g., the orientation of the mobile terminal, the accuracy of the location information) existing at the time the digital media file was created.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the disclosure.

Some embodiments can provide methods, devices, systems, and computer program products for analyzing digital media files stored on a mobile terminal. Pursuant to these embodiments, a method for classifying digital media files is provided. Geographical information from geographical identification metadata associated with each of one or more digital media files stored in a memory of a mobile terminal is obtained. A respective ranking is assigned to each of the one or more digital media files within one or more media classification categories based on the obtained geographical information.

In some embodiments, the method further includes submitting the obtained geographical information to a data source, and receiving from the data source information for ranking each of the one or more digital media files within the one or more media classification categories. Assigning the respective ranking to each of the one or more digital media files includes assigning the respective ranking based on the information received from the data source.

In further embodiments, receiving information for ranking each of the one or more digital media files includes receiving information indicating a relative popularity within the one or more media classification categories of a location identified by the submitted geographical information. Assigning the respective ranking to each of the one or more digital media files comprises assigning the respective ranking based on the relative popularity of the location.

In other embodiments, the obtained geographical information includes latitude coordinates, longitude coordinates, elevation data, altitude data, bearing data, accuracy data, and/or place name related to a respective location where each of the one or more digital media files was created.

In additional embodiments, the method further includes presenting a summary view, via a display of the mobile terminal, of the one or more ranked digital media files. The summary view includes two axes, with each of the two axes corresponding to at least one of the one or more media classification categories. A respective indicator representing each of the one or more ranked digital media files is displayed in the summary view. The positions of the respective indicators in the summary view are determined by the respective rankings of the one or more digital media files in the at least one of the one or more media classification categories corresponding to each of the two axes. In some embodiments, the positions of the respective indicators along each of the two axes is indicative of the respective rankings of the one or more digital media files in the at least one of the one or more media classification categories corresponding to each of the two axes. In other embodiments, a user selection of a home location for a user of the mobile terminal and/or for a person associated with a user of the mobile terminal is received, and the positions of the respective indicators relative to an intersection of the two axes are indicative of the distances between respective locations identified by the obtained geographical information and the home location.

In further embodiments, a user selection of a region of the summary view is received, and a user selection of an operation to be performed on at least one of the one or more digital media files having a respective indicator that is included in the selected region of the summary view is received. In some embodiments, the operation to be performed includes copying, deleting, displaying, printing, editing, annotating, classifying, tagging, uploading, e-mailing, texting, and/or electronically transmitting the at least one of the one or more digital media files.

In other embodiments, the method further includes generating a travel profile for a user of the mobile terminal. The travel profile includes the user's travel preferences as determined by the respective ranking of at least one of the one or more digital media files in at least one of the one or more of the media classification categories. In some embodiments, the method additionally includes automatically downloading from an external source information relevant to the user's travel preferences as determined by the generated travel profile, and presenting the downloaded information via a display of the mobile terminal. In further embodiments, the automatically downloaded information includes information related to travel discounts, vacation packages, weather information, and/or news alerts.

In additional embodiments, the digital media files are digital photographs and/or digital video files, and the method further includes submitting the one or more digital media files to the data source. Receiving information for ranking the one or more digital media files includes receiving image recognition results from the data source, where the image recognition results identify persons, places, objects, and/or geographic features visible in the one or more digital media files. Assigning the respective ranking to each of the one or more digital media files is based on the received image recognition results.

In some embodiments, the one or more media classification categories include a category indicating a degree to which a location may be considered urban, rural, scenic, adventure, ocean, and/or beach. In other embodiments, the one or more media classification categories include a time category, and assigning the respective rankings to each of the one or more digital media files is based on a respective timestamp associated with each of the one or more digital media files indicating a respective date and/or time that each of the one or more digital media files was created.

In further embodiments, a mobile terminal may be provided, the mobile terminal including a memory configured to store one or more digital media files, each of the one or more digital media files having associated geographical identification metadata. The mobile terminal further includes a controller configured to obtain geographical information from the geographical identification metadata associated with each of the one or more digital media files stored in the memory, and assign a respective ranking to each of the one or more digital media files within one or more media classification categories based on the obtained geographical information.

Embodiments have been described herein primarily with respect to methods for classifying digital media files having associated geographical identification metadata. However, analogous computer systems and computer program products may also be provided according to other embodiments.

Other methods, systems, and/or computer program products according to other embodiments will be or become apparent to one with skill in the art upon review of the following drawings and detailed description. It is intended that all such additional systems, methods, and/or computer program products, as well as any combinations of the above embodiments, be included within this description and be protected by the accompanying claims.

### BRIEF DESCRIPTION OF THE DRAWINGS

FIG. 1 is a block diagram illustrating a mobile terminal according to some embodiments.

FIG. 2 is a block diagram illustrating a hardware/software architecture for classifying digital media files having associated geographical identification metadata according to some embodiments.

FIGS. 3 and 4 are flowcharts illustrating example operations for classifying digital media files having associated geographical identification metadata according to some embodiments.

FIGS. 5 and 6 are flowcharts illustrating example operations utilizing the classifications of digital media files according to some embodiments.

FIGS. 7 and 8 are diagrams illustrating summary views of digital media files according to some embodiments.

### DETAILED DESCRIPTION OF EMBODIMENTS

The present invention now will be described more fully hereinafter with reference to the accompanying drawings, in which illustrated embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The terminology used herein is for the purpose of describing particular embodiments only and is not intended to be limiting of the invention. As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. In contrast, when an element is referred to as being “directly coupled” or “directly connected” to another element, there are no intervening elements present. Furthermore, “connected” or “coupled” as used herein may include wirelessly connected or coupled. As used herein, the term “and/or” includes any and all combinations of one or more of the associated listed items, and may be abbreviated as “/”.

It will also be understood that, although the terms first, second, etc. may be used herein to describe various elements, these elements should not be limited by these terms. These terms are only used to distinguish one element from another. For example, a first digital media file could be termed a second digital media file, and, similarly, a second digital media file could be termed a first digital media file without departing from the teachings of the disclosure.

As will be appreciated by one of skill in the art, the present invention may be embodied as methods, devices, and/or computer program products. Accordingly, the present invention may be embodied in hardware and/or in software (including firmware, resident software, micro-code, etc.). Computer program code for carrying out operations of devices and/or systems discussed herein may be written in a high-level programming language, such as Java, C, and/or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller. The program code may execute entirely on a single processor and/or across multiple processors, as a stand-alone software package, or as part of another software package. The program code may execute entirely on an electronic device or only partly on the electronic device and partly on another device. In the latter scenario, the other device may be connected to the electronic device through a wired and/or wireless local area network (LAN) and/or wide area network (WAN), or the connection may be made to an external computer (for example, through the Internet using an Internet Service Provider).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

For purposes of illustration, some embodiments of the present invention are described herein in the context of a mobile terminal including digital media files having associated geographical identification metadata. As used herein, the term “mobile terminal” may include a conventional cell phone; a Personal Communications System (PCS)/smart phone that may include data processing, voice, video, photography, text message, e-mail and/or Web access capabilities; a Personal Digital Assistant (PDA) with wireless communications capabilities; a wireless pager; a wireless handheld e-mail device; a netbook or notebook computer with wireless capabilities; a radio; and/or other portable electronic devices that include a wireless transceiver. The mobile terminal may include an integrated digital camera, and may further include a position or location receiver providing position/location functionality. The position/location functionality may be implemented using conventional location techniques, such as those utilizing uplink signal location, downlink signal location, and/or other approaches based on the Global Positioning System (GPS), Galileo, and/or GLONASS global navigation satellite systems. As used herein, the term “digital media file” may include digital photographs, video files, audio files, and/or any other multimedia files.

Methods, devices, and computer program products are disclosed herein that may be used to classify digital media files stored on a mobile terminal and having associated geographical identification metadata, and further may be used to generate a summary view to facilitate the visualization and selection of digital media files and to provide additional information to a user of the mobile terminal based on the classification of digital media files.

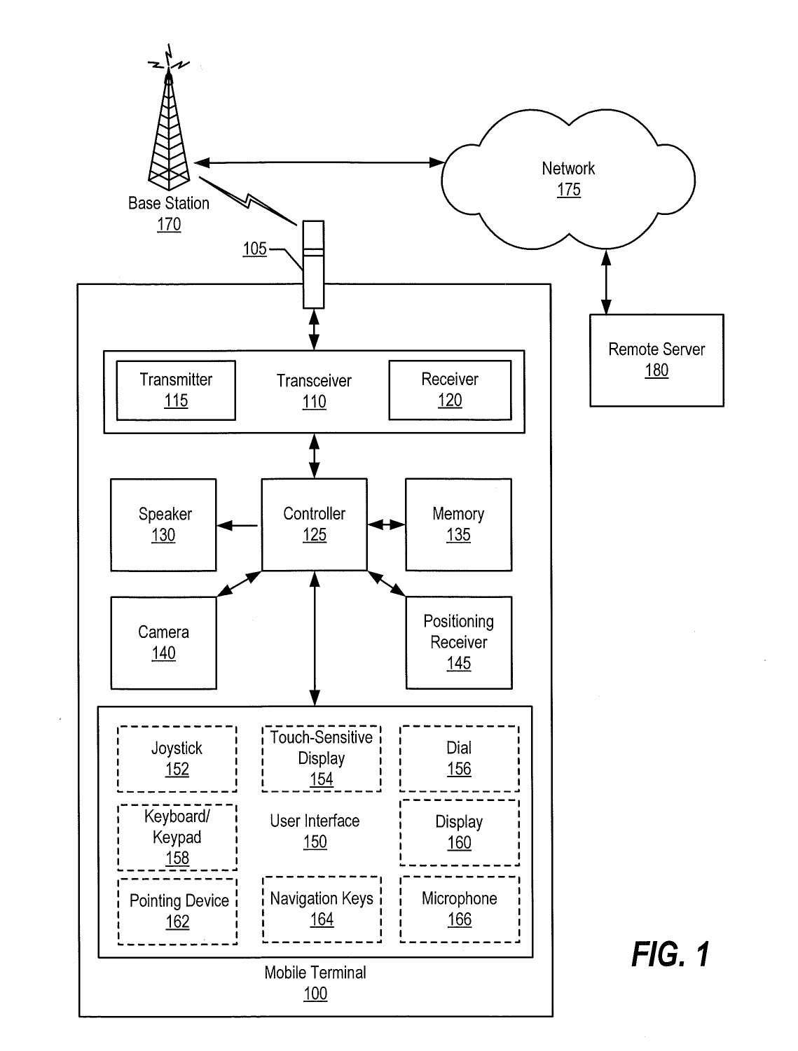

FIG. 1 is a block diagram illustrating a mobile terminal in accordance with some embodiments. Referring now to FIG. 1, an exemplary mobile terminal 100 includes a transceiver 110, a controller 125, a speaker 130, memory 135, a camera 140, a positioning receiver 145, and a user interface 150. The transceiver 110 typically includes a transmitter circuit 115 and a receiver circuit 120 which cooperate to transmit and receive radio frequency signals to and from base station transceiver 170 via an antenna 105. The radio frequency signals transmitted between the mobile terminal 100 and base station transceiver 170 may include both traffic and control signals (e.g., paging signals/messages for incoming calls), which are used to establish and maintain communication with another party or destination. The radio frequency signals may also include packet data information, such as, for example, cellular digital packet data (CDPD) or General Packet Radio Services (GPRS) information. In addition, the transceiver 110 may include an infrared (IR) transceiver configured to transmit/receive infrared signals to/from other electronic devices via an IR port, and/or may include a short-range radio transceiver configured to transmit/receive radio signals to/from other electronic devices using, for instance, Bluetooth, Near Field Communications (NFC), or Wireless Local Area Network (WLAN) communications technologies. The memory 135 may represent a hierarchy of memory that may include volatile and/or non-volatile memory, such as removable flash, magnetic, and/or optical rewritable non-volatile memory. The camera 140 may include a complementary metal-oxide-semiconductor (CMOS) or a charge-coupled device (CCD) image sensor, and may be capable of capturing still images or video.

The controller 125 is coupled to the transceiver 110, the speaker 130, the memory 135, the camera 140, the positioning receiver 145, and the user interface 150. The controller 125 may be, for example, a commercially available or custom microprocessor that is configured to coordinate and manage operations of the transceiver 110, the speaker 130, the memory 135, the camera 140, the positioning receiver 145, and the user interface 150. The controller 125 may be further configured to communicate with a remote server 180 over a network 175 via base station 170.

As noted above, the mobile terminal 100 may further include a user interface 150 coupled to the controller 125. The user interface 150 may include a joystick 152, a touch sensitive display 154, a dial 156, a keyboard/keypad 158, a display 160 (such as a liquid crystal display), a pointing device 162 (such as a mouse, trackball, touch pad, etc.), navigation key(s) 164, and/or a microphone 166. For example, the keyboard/keypad 158 may be operable to define alphanumeric characters/symbols on the display 160. However, depending on functionalities offered by the mobile terminal 100, additional and/or fewer elements of the user interface 150 may actually be provided. For instance, the touch sensitive display 154 may functionally replace a display 160, a keypad 158, and/or a pointing device 162. The touch sensitive display 154 may display a plurality of virtual command and/or control buttons. The command/control buttons may be selected by touching a stylus or finger on the touch sensitive display 154 at the appropriate location(s) of the virtual buttons shown on the touch sensitive display 154, for example, to select and/or launch an application via a displayed menu screen. The foregoing components of the mobile terminal 100 may be included in many conventional mobile terminals and their functionality is generally known to those skilled in the art. As will be explained in detail below, the controller 125 and the memory 135 are configured in accordance with at least one embodiment described herein.

The mobile terminal 100 also includes a positioning receiver 145. The positioning receiver 145, in cooperation with the controller 125, may provide a processing circuit configured to process ranging signals, for example, as received from GPS satellites. As such, the controller 125 may be configured to determine and/or calculate positioning data indicating changes in the location of the mobile terminal 100 based on the GPS communication signals received via the positioning receiver 145. However, in some embodiments, the controller 125 and/or the positioning receiver 145 may be configured to determine the positioning data for the mobile terminal 100 using other well-known techniques, such as radiolocation and/or trilateration. Also, the positioning receiver 145 may be configured to determine the positioning data based on communication signals received from other positioning systems, such as the Galileo and/or GLONASS satellite navigation systems. The positioning receiver may share the antenna 105 with the transceiver 110 in some embodiments. In further embodiments, the controller 125 and/or the positioning receiver 145 may be configured to generate and associate geographical identification metadata with a digital photograph or video captured using camera 140 or with audio recorded using microphone 166. The geographical identification metadata may be based on positioning data for the mobile terminal 100 at the time the photograph, video, and/or audio is captured using camera 140 and/or microphone 166.

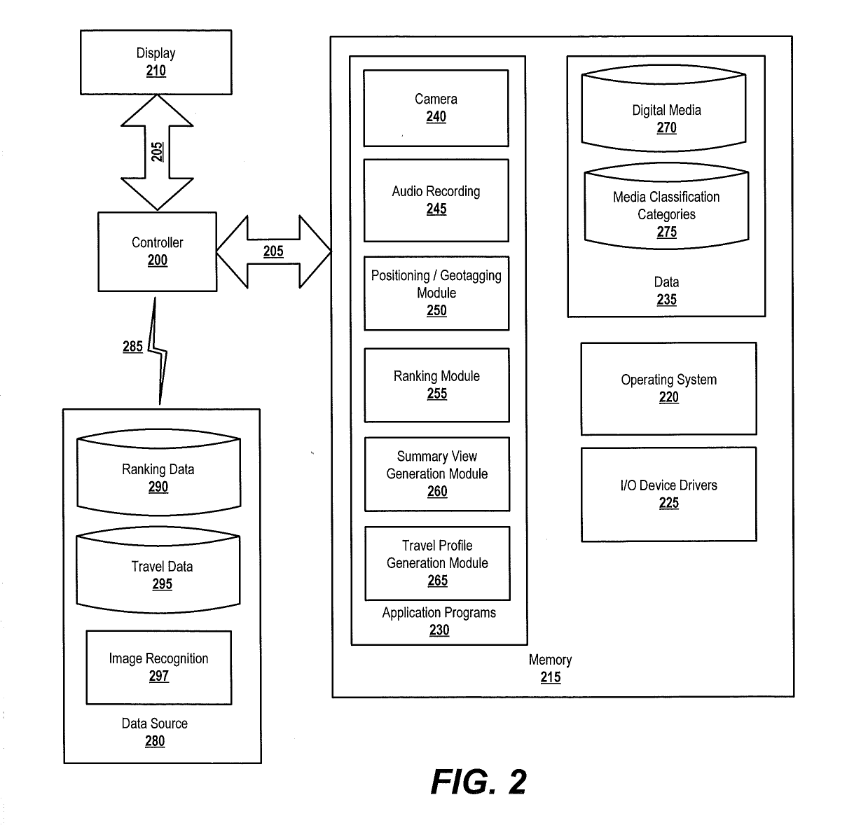

FIG. 2 illustrates a hardware/software architecture including a controller 200, a display 210, a memory device 215, and a data source 280 that may be used to classify digital media files stored on a mobile terminal according to some embodiments, such as the mobile terminal 100 of FIG. 1. In some embodiments, the controller 200, display 210, memory 215, and data source 280 may respectively correspond to the controller 125, display 160, memory 135, and remote server 180 of FIG. 1.

Referring now to FIG. 2, the controller 200 is configured to communicate with the display 210 and the memory 215 via a data bus 205, and is further configured to communicate with data source 280 via network connection 285. The display 210 may be configured to display data that is provided via the controller 200. The memory 215 may be configured to store several categories of software, such as an operating system 220, input/output (I/O) device drivers 225, and applications programs 230. The operating system 220 controls the management and/or operation of system resources and may coordinate execution of programs by the controller 200. The I/O device drivers 225 typically include software routines accessed through the operating system 220 by the application programs 230 to communicate with input/output devices, such as those included in the user interface 150 of FIG. 1, and/or other components of the memory 215. The memory 215 further includes data 235 for the application programs 230.

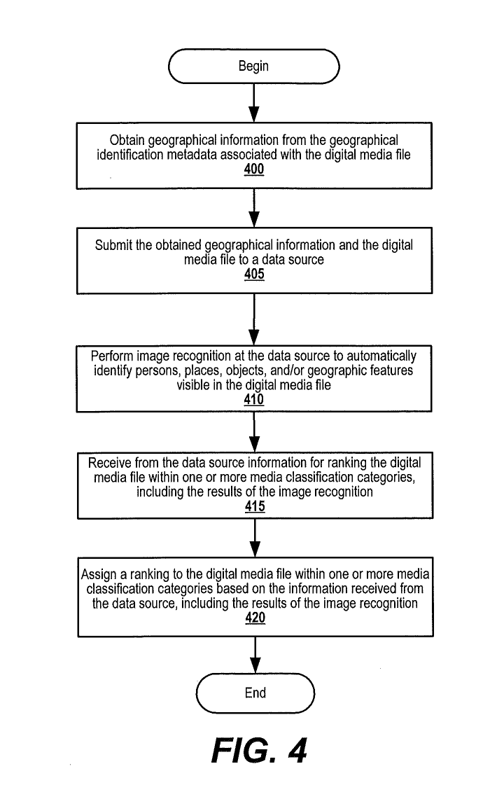

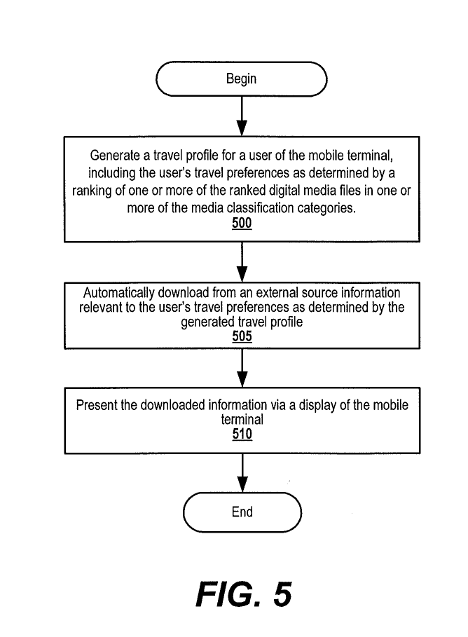

Data source 280 may include various databases and applications relevant to classifying digital media files and utilizing the classification of digital media files, and, in particular, may include ranking data database 290 and travel data database 295. For example, ranking data database 290 may include data regarding the relative popularity of locations within various classification categories—e.g., data indicating that New York City is more highly ranked in an “urban” category but is ranked lower in a “beach” category, while Honolulu is ranked relatively highly in both the “urban” and “beach” categories. Travel data database 295 may contain information potentially relevant to the travel preferences of a user as determined by the classification of the digital media files for that user, as discussed in greater detail with respect to FIG. 5. Such information may include, for instance, travel discounts, vacation packages, weather information, and/or news alerts related to locations in which the user may have an interest, as evidenced by the user's determined travel preferences. Data source 280 may further include image recognition functionality 297, which identifies certain graphical aspects of a digital image and provides image attributes for use in categorizing the image. For example, the image recognition functionality 297 may identify persons, places, objects, and/or geographic features visible in the digital image, which may facilitate the classification of the digital image, as discussed in more detail with respect to FIG. 4. It will be understood that, although data source 280 is represented in FIG. 2 as a remote server communicatively coupled with controller 200 via network connection 285, in some embodiments, the functionality associated with data source 280 may be integrated in part or in whole into controller 200 and/or memory 215, and/or may be provided by multiple remote servers.

The application programs 230 are illustrative of programs that implement various features according to embodiments of the present invention, and preferably include at least one application which supports operations for assigning a ranking to a digital media file. More particularly, the application programs 230 may include a camera application 240, an audio recording application 245, a positioning and geotagging module 250, a ranking module 255, a summary view generation module 260, and a travel profile generation module 265.

The data 235 stored in the memory 215 may include various databases that may be associated with the application programs 230. In particular, the data 235 may include a digital media database 270 and a media classification category database 275. For example, the digital media database 270 may store image, video, and/or audio files captured via the camera application 240 and/or the audio recording application 245. Digital media database 270 may also store media-related data associated with the digital media files, such as metadata and/or information related to the classification of digital media files. In addition, a database may be associated with multiple application programs. For example, the digital media database may store image files that are viewable by both the camera application 240 as well as an image viewer application (not shown). The databases 270 and 275 may be internally stored in the memory 215 of the electronic device; however, the databases 270 and 275 may not be necessarily stored in the same physical memory unit. For example, the media classification category database 275 may be stored in a non-removable memory of a mobile terminal, while the digital media database 270 may be stored in a removable memory device associated with the mobile terminal, such as a memory card.

Still referring to FIG. 2, the positioning/geotagging module 250, in some embodiments, may be configured to associate geographical identification metadata, or “geotags,” with digital media files generated using camera application 240 and/or audio recording application 245. The metadata may be incorporated into the digital media file itself in, for instance, Exchangeable Image File (EXIF) or Extensible Metadata Platform (XMP) format, or may exist separately in an associated metadata file. The geographical identification metadata typically will include latitude and longitude coordinates corresponding to the location where the digital media file was created, and may further include additional information such as elevation, altitude, bearing, accuracy data, and/or place name

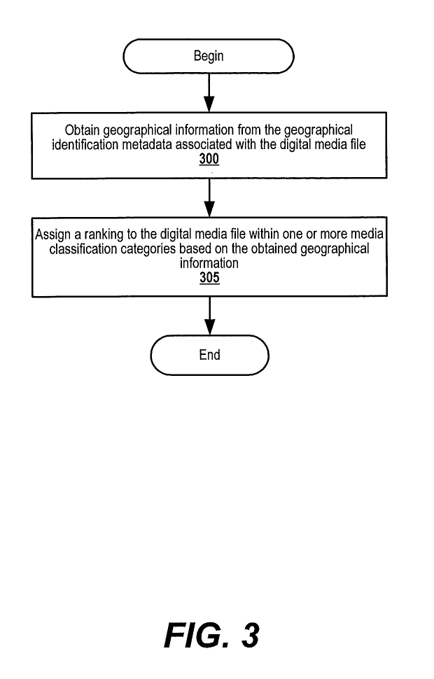

Ranking module 255, in some embodiments, is configured to analyze digital media files in digital media database 270 and determine the ranking for each analyzed digital media file in one or more of the categories in media classification category database 275. More particularly, ranking module 255 determines or obtains geographical information from the geographical identification metadata associated with each digital media file, and assigns a ranking to the digital media file within one or more of the media classification categories based on the obtained geographical information. In some embodiments, ranking module 255 may submit the obtained geographical information to and receive information for ranking a digital media file from data source 280. In other embodiments, ranking module 255 may submit the obtained geographical information and the digital media file itself to data source 280, and may receive information including the results of image recognition processing performed by image recognition functionality 297 of data source 280. The operation of ranking module 255 in some embodiments is discussed in greater detail with respect to FIGS. 3 and 4.

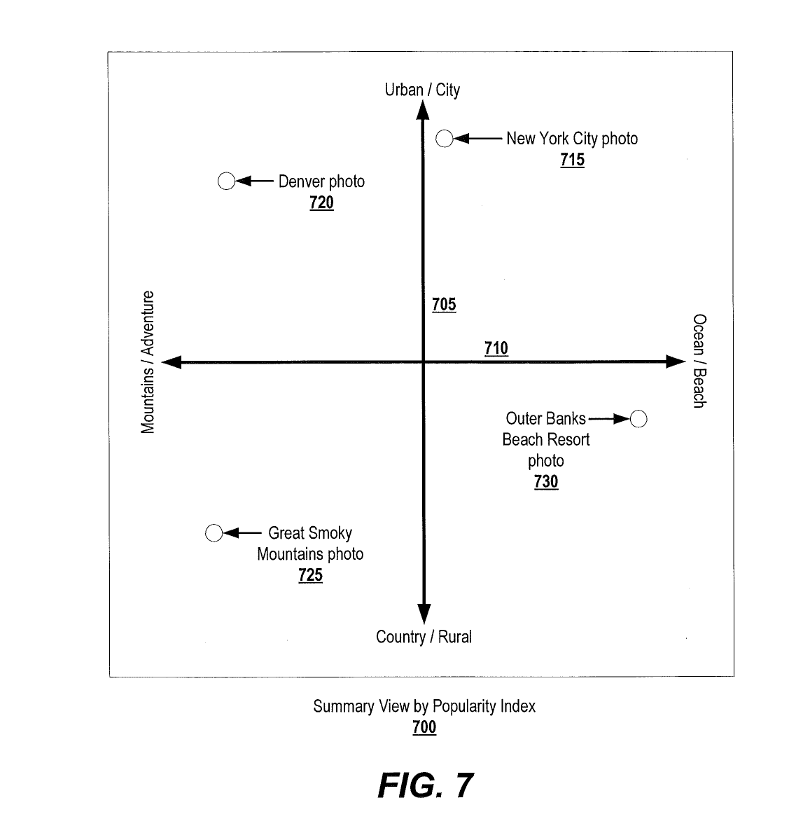

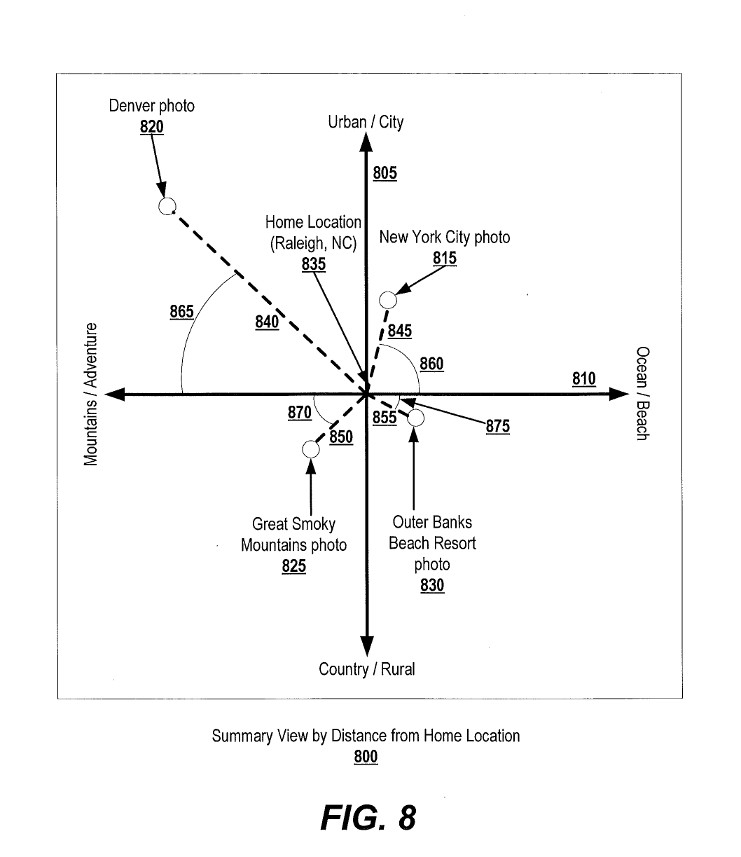

In some embodiments, summary view generation module 260 is configured to generate a summary view of the ranked digital media files on display 210. Specifically, summary view generation module 260 is configured to create a two-axis display, with each axis corresponding to one or more media classification categories. In some embodiments, summary view generation module 260 may be configured to receive a user selection of one or more media classification categories available from media classification category database 275, and to associate the selected one or more media classification categories with one or both of the two axes. In other embodiments, the summary view generation module 260 may be configured to create the display by associating one or both of the two axes with one or more default media classification categories from media classification category database 275. An indicator representing each ranked digital media file is displayed on the summary view. In some embodiments, as illustrated by FIG. 7, the position of the indicator along each axis indicates the assigned ranking of the digital media file in the media classification category or categories corresponding to each axis. For instance, if one axis represents the degree to which a location may be considered “urban” versus “rural,” a digital media file that was ranked highly in the “urban” category would be represented by an indicator displayed further towards the “urban” end of the axis. In further embodiments, as illustrated by FIG. 8, the position of the indicator relative to the intersection of the two axes indicates the distance between the location at which the digital media file was created and a location specified by the user as a “home location,” and the inclination of a line extending from the indicator to the intersection of the two axes indicates the relative rankings of the digital media file represented by the indicator in the media classification categories corresponding to the two axes.

Travel profile generation module 265 is configured in some embodiments to generate a travel profile for a user of the mobile terminal, based on a ranking of one or more of the ranked digital media files in one or more media classification categories. The travel profile may include, for instance, determinations with respect to the type of destination favored by the user, whether the user favors domestic versus international travel, and/or the user's preferred travel times (e.g., the time of year in which the user tends to travel more frequently). Based on the generated travel profile, travel profile generation module 265 may retrieve from data source 280 information relevant to the user's travel preferences as determined by the travel profile. Such information may include, for instance, travel discounts, vacation packages, weather information, and/or news alerts related to locations in which the user may have an interest, as evidenced by the user's determined travel preferences. The retrieved information may then be displayed to the user via display 210.

Although FIG. 2 illustrates an exemplary hardware/software architecture that may be used in mobile terminals and/or other electronic devices for classifying digital media files having associated geographical identification metadata, it will be understood that the present invention is not limited to such a configuration but is intended to encompass any configuration capable of carrying out operations described herein. In addition, although the memory 215 is illustrated as separate from the controller 200, the memory 215 or portions thereof may be considered as a part of the controller 200. More generally, while particular functionalities are shown in particular blocks by way of illustration, functionalities of different blocks and/or portions thereof may be combined, divided, and/or eliminated. In particular, the functionality associated with data source 280 and or data source 280 itself may be incorporated into and provided by controller 200 and/or memory 215 and/or may be provided by multiple remote servers. Moreover, the functionality of the hardware/software architecture of FIG. 2 may be implemented as a single processor system or a multi-processor system in accordance with various embodiments of the present invention.

Computer program code for carrying out operations of devices and/or systems discussed above with respect to FIG. 2 may be written in a high-level programming language, such as Java, C, and/or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

The present invention is described hereinafter with reference to flowchart and/or block diagram illustrations of methods, mobile terminals, electronic devices, data processing systems, and/or computer program products in accordance with some embodiments of the invention.

These flowchart and/or block diagrams further illustrate exemplary operations for providing classification of digital media files based on associated geographical identification metadata in accordance with various embodiments of the present invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

FIGS. 3 and 4 are flowcharts illustrating example operations for classifying digital media files having associated geographical identification metadata according to some embodiments. Referring now to FIG. 3, at block 300, geographical information is obtained from the geographical identification metadata associated with a digital media file stored on a mobile terminal. The obtained geographical information may be submitted to a data source, and information for ranking the digital media file within one or more media classification categories may be received from the data source. The received information may include, for example, information indicating the relative popularity within the one or more media classification categories of a location identified by the submitted geographical information. Thus, for instance, the submitted geographical information may identify New York City as the location, and the received information may include a “popularity index” indicating that New York City is more popular as an “urban” travel destination but less popular as a “beach” travel destination. At block 305, a ranking is assigned to the digital media file within one or more media classification categories based on the information received from the data source. Digital media files having geographical identification metadata associated with New York City, for instance, would be assigned a higher ranking in an “urban” media classification category, and a lower ranking in a “beach” media classification category.

FIG. 4 illustrates example operations for classifying digital media files having associated geographical identification metadata according to further embodiments. At block 400, geographical information is obtained from the geographical identification metadata associated with a digital media file stored on a mobile terminal. The obtained geographical information and the digital media file itself are submitted to a data source at block 405. At block 410, image recognition is performed at the data source to automatically identify persons, places, objects, and/or geographic features visible in the digital media file. The geographical information submitted to the data source may be utilized to facilitate the image recognition of, for example, places, objects and/or geographic features. The data source may communicate with the mobile terminal to confirm the results of the image recognition—for instance, to confirm a recognized object. At block 415, information for ranking the digital media file within one or more media classification categories, including the results of the image recognition, is received from the data source. Finally, at block 420, a ranking is assigned to the digital media file within one or more media classification categories based on the information received from the data source, including the results of the image recognition.

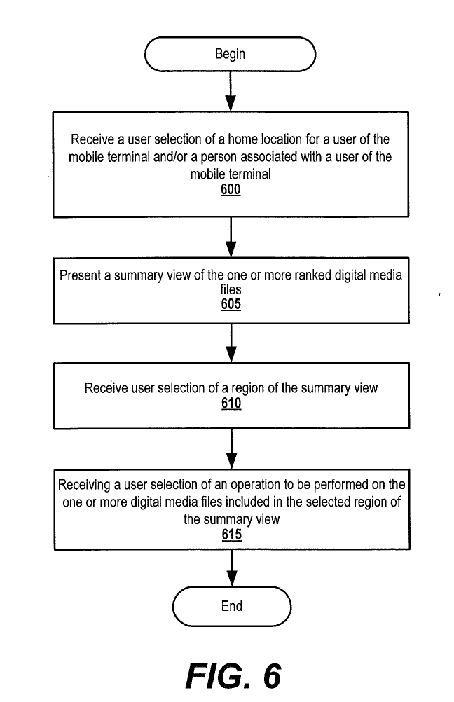

The classification of digital media files based on associated geographical identification metadata may further enable additional operations utilizing the classifications. FIGS. 5 and 6 are flowcharts illustrating example operations utilizing the classifications of digital media files according to some embodiments. In FIG. 5, at block 500, a travel profile is generated for a user of the mobile terminal. The travel profile may include the user's travel preferences as determined by a ranking of one or more of the ranked digital media files in one or more of the media classification categories. For instance, if the user has a large number of digital photos that have been assigned a high ranking in a “beach” media classification category, the travel profile may include an indication that beach destinations are favored by the user. At block 505, information relevant to the user's travel preferences as determined by the generated travel profile is automatically downloaded from an external source. For a user who frequents beach destinations, for example, the information may include travel discounts to the Outer Banks, vacation packages to Maui, and/or weather alerts for the Caribbean. At block 510, the downloaded information may be presented to the user via a display of the mobile terminal.

In this way, some embodiments may provide the user with information and/or leads for his subsequent vacations or travel based on factors such as the weather patterns at locations in each of his favorite categories, or the lowest cost travel packages or deals available at a given time. For instance, a travel profile may be generated for user Bob, indicating that (a) Bob likes “Urban/City” travel destinations the most; (b) Bob travels to a new city every spring for vacation; (c) Bob usually travels within the country, and (d) Bob travels most frequently during the months of May and June. Based on these inferences, some embodiments may provide alerts to Bob such as, for example, (a) a hot travel deal, sourced from Expedia.com, available for San Francisco from May 4 to May 14; and/or (b) a weather advisory warning from Weather.com that hurricane activity is expected to soak East Coast cities during May.

Referring now to FIG. 6, at block 600, a user selection of a home location for a user of the mobile terminal and/or a person associated with a user of the mobile terminal is received. The selected home location may indicate, for instance, the location where the user resides, or may indicate where friends and/or family of the user live. At block 605, a summary view of the one or more ranked digital media files is presented. The summary view, in some embodiments, includes two axes, with each axis corresponding to one or more of the media classification categories. In some embodiments, the summary view may display indicators for the ranked digital media files indicating their rankings in the media classification categories corresponding to the two axes, as discussed further with respect to FIG. 7. In other embodiments, the summary view may display indicators for the ranked digital media files indicative of the distance between the location at which the digital media file was created and the home location, as discussed in more detail with respect to FIG. 8. The summary view in the described embodiments may provide features allowing the user to, for instance, show his friends the most urban city or location that he has visited, or show the most distant beach resort or urban city that he may have traveled to.

At block 610, a user selection of a region of the summary view is received. The selected region may include, for example, the entire area above or below or to the left or right of an axis, may be limited one or more specific quadrants of the summary view, or may comprise some other user-defined region. At block 615, a user selection of an operation to be performed on the one or more digital media files having indicators included in the selected region of the summary view may be received. The operation may include, for example, copying, deleting, displaying, printing, editing, annotating, classifying, tagging, uploading, e-mailing, texting (e.g., via Multimedia Messaging Service (MMS)), or otherwise electronically transmitting the one or more digital media files having indicators included in the selected region of the summary view. In some embodiments, thus, the summary view may aid the user in visualizing the categorization of digital media files, and allow the user to select one or more digital media files based on where the indicators displayed for the files appear in the summary view—for instance, in a specific quadrant of the summary view. In this way, for example, the user may easily select only digital photos taken at beach locations for use as a desktop wallpaper or screensaver.

It will be understood that, in some embodiments, the operations described in FIGS. 3-6 may be performed entirely by a device such as, for example, a mobile terminal, a standalone personal computer, or a networked server computer. In other embodiments, the operations described in FIGS. 3-6 may be performed by a combination of two or more devices, with each device performing a subset of the operations.

FIGS. 7 and 8 are diagrams illustrating summary views of digital media files according to some embodiments. FIG. 7 illustrates summary view 700 wherein the position of the indicators for each digital media file along each axis indicates the digital media file's ranking in the media classification category or categories corresponding to that axis. In summary view 700, for example, horizontal x-axis 710 represents a continuum from “Mountains/Adventure” at the leftmost extreme to “Ocean/Beach” at the rightmost extreme, while the vertical y-axis 705 represents a continuum from “Urban/City” at the upper extreme to “Country/Rural” at the lower extreme. It will be understood that an axis may be associated with a single media classification category, or may be associated with more than one complementary categories. For instance, y-axis 705 may be associated with a single media classification category representing the degree to which a location associated with a digital media file may be considered “urban,” or may be associated with two complementary categories, such as “urban” and “rural,” in which a digital media file's ranking in one category generally will be the inverse of its ranking in the other category. The exact position of the indicators for each digital media file is determined by a point (x,y), with each of the x and y coordinates being determined by the ranking of the digital media file in the media classification category or categories corresponding to the x and y axes, respectively.

Still referring to FIG. 7, summary view 700 displays indicators for four digital photos that have been ranked according to the method described herein: New York City photo indicator 715; Denver photo indicator 720; Great Smoky Mountains photo indicator 725; and Outer Banks Beach Resort photo indicator 730. The digital photo represented by New York City photo indicator 715 is assigned a relatively high “Urban/City” ranking (i.e., New York City is more closely associated with the idea of “Urban/City”), and, as a result, New York City photo indicator 715 is vertically positioned towards the upper end of vertical y-axis 705. Since New York City is generally neutral on the “Mountains/Adventure” versus “Ocean/Beach” continuum, the horizontal position of New York City photo indicator 715 on x-axis 710 is closer to vertical y-axis 705.

The digital photo represented by Denver photo indicator 720 is also assigned a relatively high “Urban/City” ranking; unlike New York City, however, Denver is much more strongly associated with mountains, and therefore the photo represented by Denver photo indicator 720 is assigned a relatively high “Mountains/Adventure” ranking as well. As a result, Denver photo indicator 720 is displayed in summary view 700 towards the upper end of vertical y-axis 705, and well towards the left end of horizontal x-axis 710.

In contrast with the digital photos represented by New York City photo indicator 715 and Denver photo indicator 720, the photo represented by Great Smoky Mountains photo indicator 725 is assigned a much lower “Urban/City” ranking (or, inversely, a much higher “Country/Rural” ranking). The photo represented by Great Smoky Mountains photo indicator 725, though, is also assigned a relatively high “Mountains/Adventure” ranking, and as a result, Great Smoky Mountains photo indicator 725 is positioned in summary view 700 towards the lower end of vertical y-axis 705 and well towards the left end of horizontal x-axis 710.

Unlike the other photos, the photo represented by Outer Banks Beach Resort photo indicator 730 is assigned a high “Ocean/Beach” ranking. While not considered as rural as the photo represented by Great Smoky Mountains photo indicator 725, the photo represented by Outer Banks Beach Resort photo indicator 730 still is assigned a ranking closer to “Country/Rural” than “Urban City.” Thus, the Outer Banks Beach Resort photo indicator 730 is displayed in summary view 700 slightly below the center of the display on vertical y-axis 705, but well towards the right end of horizontal x-axis 710.

FIG. 8 illustrates summary view 800 in which the position of the indicators for each digital media file are determined in part by the distance between the location at which the digital media file was created and the home location. As with summary view 700 in FIG. 7, summary view 800 includes vertical y-axis 805 representing a continuum from “Urban/City” to “Country/Rural,” while horizontal x-axis 810 represents a continuum from “Mountains/Adventure” to “Ocean/Beach.” Unlike summary view 700, however, the exact position of the indicator for each displayed digital media file is not determined by its ranking in the category or categories associated with each axis. Instead, in summary view 800, the origin 835, or intersection of the axes, represents a home location selected by a user of the mobile terminal—here, Raleigh, N.C. The ranking of each digital media file determines in which quadrant of summary view 800 the corresponding indicator is displayed, while the exact position of the indicator in a quadrant is determined by an inclination and a line through the origin whose length represents the geographical distance between the location where the digital media file was created and the home location selected by the user. The length of the line representing the geographical distance may be directly proportion to the geographical distance, or the length may be scaled using, for instance, a logarithmic or exponential scale, to better accommodate varied locations across the globe.

The inclination of the line is determined by the relative rankings of the digital media file in the media classification categories corresponding to the two axes, such that the indicator is positioned closer to the axis with which the digital media file is more highly ranked (i.e., more strongly associated). For example, for an indicator located in the upper right quadrant, an inclination of 60 degrees from the horizontal would indicate that the digital media file represented by the indicator is more highly ranked in the media classification category corresponding to the upper portion of y-axis 805 than in the media classification category corresponding to the right portion of x-axis 810. An inclination of 45 degrees, in contrast, would indicate that the digital media file has similar rankings in both media classification categories.

For example, in summary view 800, the indicators for digital media files assigned a ranking closer to “Urban/City” appear above horizontal x-axis 810, while those for digital media files assigned a ranking closer to “Country/Rural” appear below horizontal x-axis 810. Likewise, the indicators for digital media files assigned a ranking closer to “Mountains/Adventure” appear to the left of the vertical y-axis 805, and those for digital media files assigned a ranking closer to “Ocean/Beach” are displayed to the right of vertical y-axis 805. The distance of each indicator from origin 835 is determined by the distance between the location where the digital media file represented by the indicator was created and home location Raleigh, N.C. The inclination of the line extending from each indicator to origin 835 is determined by the relative rankings of the digital media file represented by each indicator in the media classification categories corresponding to the two axes.

Thus, Denver photo indicator 820 appears in the upper left quadrant, because the digital photo represents is assigned relatively high rankings in both the “Urban/City” and “Mountains/Adventure” categories. Because Denver is relatively distant from Raleigh, the distance between Denver photo 820 indicator and intersection 835, represented by dotted line 840, is relatively large. The rankings of the digital photo represented by Denver photo indicator 820 in the “Urban/City” and “Mountains/Adventure” categories are comparable, so the inclination 865 of line 840 from horizontal is approximately 45 degrees, which places Denver photo indicator 820 approximately equidistant from x-axis 810 and y-axis 805.

New York City photo indicator 815 appears in the upper right quadrant because the photo it represents is assigned a relatively high “Urban/City” ranking and is ranked closer to “Ocean/Beach” than “Mountain/Adventure.” The distance between New York City photo indicator 815 and intersection 835, represented by dotted line 845, indicates that New York is significantly closer to Raleigh than Denver is. Because the digital photo represented by New York City photo indicator 815 is ranked higher in the “Urban/City” category than in the “Ocean/Beach” category, the inclination 860 of line 845 is approximately 75 degrees from horizontal, placing New York City photo indicator 815 closer to y-axis 805.

Great Smoky Mountain photo indicator 825 is displayed in the lower left quadrant, as it represents a digital photo taken at a location ranked both as “Mountains/Adventure” and “Country/Rural.” The distance between Great Smoky Mountain photo indicator 825 and intersection 835, represented by dotted line 850, represents the relative proximity of the Great Smoky Mountains to Raleigh. The rankings of the digital photo represented by Great Smoky Mountain photo indicator 825 in the “Mountains/Adventure” and “Country/Rural” categories are comparable, so the inclination 870 of line 850 from horizontal is approximately 45 degrees, placing Great Smoky Mountain photo indicator 825 roughly equidistant from x-axis 810 and y-axis 805.

Finally, Outer Banks Beach Resort photo indicator 830 is displayed in the lower right quadrant, as it represents a digital photo taken at a location ranked both as “Ocean/Beach” and as “Country/Rural.” The distance between Outer Banks Beach Resort photo indicator 830 and intersection 835, represented by dotted line 855, indicates that the Outer Banks and Raleigh are relatively close geographically. Because the digital photo represented by Outer Banks Beach Resort photo indicator 830 is ranked higher in the “Ocean/Beach” category than in the “Country/Rural” category, the inclination 875 of line 855 is approximately 25 degrees from horizontal, placing Outer Banks Beach Resort photo indicator 830 closer to x-axis 805.

In the drawings and specification, there have been disclosed exemplary embodiments of the invention, and although specific terms are used, they are used in a generic and descriptive sense only and not for purposes of limitation, the scope of the invention being defined by the following claims.

That which is claimed:

1. A method for classifying digital media files, the method comprising:
obtaining geographical information from geographical identification metadata associated with each of one or more digital media files stored in a memory of a mobile terminal; and
assigning a respective ranking to each of the one or more digital media files within one or more media classification categories based on the obtained geographical information;
wherein the obtaining and/or the assigning comprise operations performed using a programmed processor circuit.

2. The method according to claim 1, further comprising:
submitting the obtained geographical information to a data source; and
receiving, from the data source, information for ranking each of the one or more digital media files within the one or more media classification categories;
wherein assigning the respective ranking to each of the one or more digital media files comprises assigning the respective ranking based on the information received from the data source.

3. The method of claim 2, wherein receiving information for ranking each of the one or more digital media files includes receiving information indicating a relative popularity within the one or more media classification categories of a location identified by the submitted geographical information; and
wherein assigning the respective ranking to each of the one or more digital media files comprises assigning the respective ranking based on the relative popularity of the location.

4. The method of claim 1, wherein the obtained geographical information includes latitude coordinates, longitude coordinates, elevation data, altitude data, bearing data, accuracy data, and/or place name related to a respective location where each of the one or more digital media files was created.

5. The method according to claim 1, further comprising:
presenting a summary view, via a display of the mobile terminal, of the one or more ranked digital media files, the summary view including two axes, each of the two axes corresponding to at least one of the one or more media classification categories; and
displaying a respective indicator representing each of the one or more ranked digital media files in the summary view;
wherein positions of the respective indicators in the summary view are determined by the respective rankings of the one or more digital media files in the at least one of the one or more media classification categories corresponding to each of the two axes.

6. The method according to claim 5, wherein the positions of the respective indicators along each of the two axes is indicative of the respective rankings of the one or more digital media files in the at least one of the one or more media classification categories corresponding to each of the two axes.

7. The method according to claim 5, the method further comprising:
receiving a user selection of a home location for a user of the mobile terminal and/or for a person associated with a user of the mobile terminal;
wherein the positions of the respective indicators relative to an intersection of the two axes are indicative of the distances between respective locations identified by the obtained geographical information and the home location.

8. The method according to claim 5, further comprising:
receiving a user selection of a region of the summary view; and
receiving a user selection of an operation to be performed on at least one of the one or more digital media files having a respective indicator that is included in the selected region of the summary view.

9. The method according to claim 8, wherein the operation includes copying, deleting, displaying, printing, editing, annotating, classifying, tagging, uploading, e-mailing, texting, and/or electronically transmitting the at least one of the one or more digital media files.

10. The method according to claim 1, further comprising:
generating a travel profile for a user of the mobile terminal, the travel profile including the user's travel preferences as determined by the respective ranking of at least one of the one or more digital media files in at least one of the one or more of the media classification categories.

11. The method according to claim 10, further comprising:
automatically downloading from an external source information relevant to the user's travel preferences as determined by the generated travel profile; and
presenting the downloaded information via a display of the mobile terminal.

12. The method according to claim 11, wherein the automatically downloaded information includes information related to travel discounts, vacation packages, weather information, and/or news alerts.

13. The method according to claim 2, wherein the digital media files are digital photographs and/or digital video files, and wherein the method further comprises:
submitting the one or more digital media files to the data source; and
wherein receiving information for ranking the one or more digital media files includes receiving image recognition results from the data source, the image recognition results identifying persons, places, objects, and/or geographic features visible in the one or more digital media files; and
wherein assigning the respective ranking to each of the one or more digital media files is based on the received image recognition results.

14. The method according to claim 1, wherein the one or more media classification categories include a category indicating a degree to which a location may be considered urban, rural, scenic, adventure, ocean, and/or beach.

15. The method according to claim 1, wherein the one or more media classification categories include a time category, and wherein assigning the respective rankings to each of the one or more digital media files is based on a respective timestamp associated with each of the one or more digital media files indicating a respective date and/or time that each of the one or more digital media files was created.

16. A mobile terminal, comprising:
a memory configured to store one or more digital media files, each of the one or more digital media files having associated geographical identification metadata; and
a controller configured to obtain geographical information from the geographical identification metadata associated with each of the one or more digital media files stored in the memory, and assign a respective ranking to each of the one or more digital media files within one or more media classification categories based on the obtained geographical information.

17. The mobile terminal of claim 16, wherein the controller is further configured to submit the obtained geographical information to a data source, and receive from the data source information for ranking the one or more digital media files within the one or more media classification categories; and
wherein assigning the respective ranking to each of the one or more digital media files comprises assigning the respective ranking based on the information received from the data source.

18. The mobile terminal of claim 16, further comprising:
a display configured to present a summary view of the one or more ranked digital media files, the summary view including two axes, each of the two axes corresponding to at least one of the one or more media classification categories;
wherein the display is further configured to display a respective indicator representing each of the one or more ranked digital media files in the summary view; and
wherein positions of the respective indicators in the summary view are determined by the respective rankings of the digital media files in the at least one of the one or more media classification categories corresponding to each of the two axes.

19. The mobile terminal of claim 18, further comprising:
a user interface configured to receive a user selection of a region of the summary view, and further configured to receive a user selection of an operation to be performed on at least one of the one or more digital media files having a respective indicator that is included in the selected region of the summary view;
wherein the operation includes copying, deleting, displaying, printing editing, annotating, classifying, tagging, uploading, e-mailing, texting, and/or electronically transmitting at least one of the one or more digital media files.

20. A computer program product providing the classification of digital media files stored on a mobile terminal and having associated geographical identification metadata, the computer program product comprising:
a computer readable storage medium having computer readable program code embodied in said medium, said computer readable program code comprising:
computer readable program code that, when executed by a processor, obtains geographical information from geographical identification metadata associated with each of one or more digital media files stored in a memory of a mobile terminal; and
computer readable program code that, when executed by a processor, assigns a respective ranking to each of the one or more digital media files within one or more media classification categories based on the obtained geographical information.
